(19) United States
(12) Patent Application Publication
(10) Pub. No.: US 2017/0255748 A1
(43) Pub. Date: Sep. 7, 2017

(54) MEDICAL RECORD OUTPUT MANAGEMENT METHOD AND MEDICAL RECORD OUTPUT SYSTEM

(71) Applicant: Carestream Health, Inc., Rochester, NY (US)

(72) Inventors: Jing Ma, Shanghai (CN); Hui Xiang, Shanghai (CN); Geng Shi, Shanghai (CN)

(21) Appl. No.: 15/351,554

(22) Filed: Nov. 15, 2016

(30) Foreign Application Priority Data
Mar. 1, 2016 (CN) 201610116137.2

(51) Int. Cl. G06F 19/00; G06F 17/30

(52) U.S. Cl. CPC G06F 19/322; G06F 17/30864

(57) ABSTRACT

The present invention provides a medical record output method, comprising: a) providing a first identification code, wherein the first identification code comprises patient identity information; b) acquiring the first identification code; c) acquiring output terminal identity information; d) analyzing a medical record state of a corresponding patient according to the first identification code; and e) sending a medical record of the patient to a corresponding output terminal or a medical record interaction interface when the medical record state of the patient is ready-to-output. A medical record output system is further provided.

### CROSS REFERENCE TO RELATED APPLICATIONS

This application claims priority to CN 201610116137.2 filed on Mar. 1, 2016, incorporated herein in its entirety.

### TECHNICAL FIELD

The present invention relates to a medical electronic information management technology, and more particularly, the present invention relates to a technology related to medial record output management.

### BACKGROUND ART

With the continuous development of medical electronic information management technologies, during a visit of a patient to the hospital, various medical records are generated, for example, medical image films and electronic information such as electronic reports, and the management on electronic information flows is critical for improving diagnosis efficiency for patients. After diagnosis aided by various medical equipment, a physician may operate a work station to generate a medical image film after a film is taken for a patient, and a doctor also provides some electronic reports according to a diagnosis result about a disease of the patient. To help the doctor design a subsequent therapeutic regimen according to the medical image film or the electronic report conveniently, the patient needs to get the printed paper report and the medical image film.

In a conventional method, patients queue up at a manual window for their medical image films and/or paper reports. On one hand, it is slow and inefficient to fetch medical image films and/or paper reports manually, and it even leads to crowding if there are too many patients waiting for medical image films and/or paper reports at the manual window. On the other hand, staff members of the hospital may confuse medical image films and/or paper reports when handing them out and thus make mistakes during distribution.

With the development of self-service printing technology, most hospitals provide self-service print terminals for patients, so that the patients can print their medical records by themselves. A hospital usually has multiple departments that need to output medical image films and electronic reports of different specifications. Therefore, it is necessary to dispose, in each department or at a suitable location, one or more print terminals of different types for the purpose of printing.

However, during printing, a patient needs to wait near a print terminal and personally confirm whether a medical image film and/or an electronic report has been sent to the print terminal. As patients cannot know in time whether their medical image films and/or electronic reports are already available for printing at the print terminal near which the patients are waiting, the patients have to wait in line for a long time to print the medical image films and/or electronic reports successfully. What's worse, when a patient needs to print different types of reports at different print terminals, because different types of print terminals are arranged at different places, the patient cannot know which report or film thereof is sent to which print terminal, as a result, the patient waits in anxiety and constantly checks different print terminals, wasting a lot of time.

To solve this problem, some hospitals employ a “centralized printing” manner at present. To use the centralized printing manner, a hospital needs to purchase a specialized print terminal on the basis of existing print terminals. Such a specialized print terminal integrates various types of print terminals, for example, a paper report printer and a film printer, that is, one specialized print terminal can support output of films and paper reports of multiple specifications. With such specialized print terminals, patients can go to any specialized print terminal to wait for their reports and films of various types, thus reducing time that the patients waste in waiting for reports to be printed at different print terminals.

However, on one hand, to implement such a “centralized printing” manner, the hospital needs to purchase a large quantity of additional specialized print terminals, increase investment in power line laying and the like, and even spend more money on consumables such as special films and report papers required by the specialized print terminals, causing an increase in printing costs of the hospital and further leading to an increase in medical costs of patients. On the other hand, various original print terminals of the hospital are left unused, causing a waste of fixed assets.

Therefore, to implement centralized management and printing of reports from all departments of a hospital on the basis of existing print terminals of the hospital without increasing investment in additional equipment, there is an urgent need to provide a new print system and method to solve the foregoing problem.

### SUMMARY

The present invention provides a medical record output method, which can effectively solve the problem above.

In one aspect, the present invention provides a medical record output method, comprising: a) providing a first identification code, wherein the first identification code comprises patient identity information; b) acquiring the first identification code; c) acquiring an output terminal identity information; d) analyzing a medical record state of a corresponding patient according to the first identification code; and e) sending a medical record of the patient to a corresponding output terminal or a medical record interaction interface when the medical record state of the patient is ready-to-output.

In the medical record output method described above, step d) further comprises: d1) transmitting related information of the first identification code to a medical record output server through the medical record interaction interface; d2) transmitting the output terminal identity information to the medical record output server through the medical record interaction interface; d3) performing matching analysis on the identity information included in the first identification code and medical record identity information by the medical record output server, and generating the medical record state of the corresponding patient; and d4) sending the medical record state to the medical record interaction interface.

The medical record output method described above further comprises: sending an output request to the medical record output server through the medical record interaction interface; and after receiving the output request, performing matching analysis on the identity information included in the first identification code and medical record identity information by the medical record output server, and generating the medical record state of the corresponding patient.

In the medical record output method described above, step c) further comprises: providing a second identification code, wherein the second identification code comprises the output terminal identity information; and acquiring the second identification code through the medical record interaction interface, and relating the second identification code with the output terminal identity information.

In the medical record output method described above, the second identification code one-to-one corresponds to an output terminal.

In the medical record output method described above, the second identification code corresponds to a plurality of output terminals.

In the medical record output method described above, the first identification code or the second identification code comprises a two-dimensional code, a bar code, graphical information, or text information.

In the medical record output method described above, step c) further comprises positioning a nearby output terminal by using an application program in a mobile terminal, and obtaining identity information of the output terminal.

In the medical record output method described above, an application program for acquiring the first identification code is a third-party application program installed in a mobile terminal, and the method further comprises loading an interaction interface of the medical record management system after the first identification code is acquired through the third-party application program.

In the medical record output method described above, an application program for acquiring the first identification code is a stand-alone application program for medical record query.

The medical record output method described above further comprises finding the stand-alone application program by means of online searching or by scanning an installation code, and downloading and installing the stand-alone application program in a mobile terminal.

The medical record output method described above further comprises printing the medical record by using the output terminal corresponding to the acquired output terminal identity information.

In another aspect, the present invention further provides a medical record output system, comprising: first identification code, which is related with patient identity information when being acquired by a mobile terminal; an output terminal, wherein the output terminal identity information is acquired by the mobile terminal; and a medical record output server, which is configured to analyze a medical record state of a patient corresponding to the first identification code, and send a medical record of the patient to the corresponding output terminal or a medical record interaction interface when the medical record state of the patient is ready-to-output.

Further, in the medical record output system described above: the medical record output server is configured to receive related information of the first identification code and related information of the output terminal, and perform matching analysis on the identity information included in the first identification code and medical record identity information, and generate the medical record state of the corresponding patient.

Further, in the medical record output system described above: the medical record interaction interface is configured to send an output request to the medical record output server; and after receiving the output request, if the medical record of the patient corresponding to the first identification code is ready to output, the medical record output server sends the medical record of the patient to the output terminal corresponding to the acquired output terminal identity information or the medical record interaction interface.

Execution of the medical record output method according to the examples of the present invention or use of the medical record output system can effectively improve the situation where patients need to go back and forth to acquire reports, without making any change to an existing electronic management system of a medical institution. On one hand, the medical record printing efficiency is improved for patients, and the patients spend less time on queuing up. On the other hand, a hospital does not need to additionally purchase specialized print devices, which reduces costs.

### BRIEF DESCRIPTION OF THE DRAWINGS

FIG. 1 is a flow chart of a medical record output method according to an example of the present invention;

FIG. 2 is a flow chart of a medical record output method according to another example of the present invention; and

FIG. 3 is a structural schematic diagram of a medical record output system according to an example of the present invention.

### DETAILED DESCRIPTION

Exemplary examples of the present invention are now described with reference to the accompanying drawings, where same reference numbers represent same elements. The examples described below help a person skilled in the art comprehend the present invention thoroughly, and the examples are used for the illustrative rather than limitative purpose. The illustration of elements, components, modules, apparatuses, and device bodies in the figures merely schematically indicates the existence of as well as relative relationships among such elements, components, modules, apparatuses, and device bodies, but is not intended to limit specific shapes thereof. The terms “first” and “second” mentioned in the following description are merely used to differentiate different parts but do not indicate any sequence. The relationships between steps in the flow charts are not limited to the provided sequences either, but can be adjusted according to an actual application without departing from the protection scope of this application.

A medical record output method provided according to the examples of the present invention can be applied to existing medical management systems of hospitals. Herein, the existing medical management systems generally refer to various patient-related electronic systems currently used in hospitals, for example, a hospital information system (HIS), a laboratory management system (LIS), a picture archiving and communication system (PACS), a radiology information system (RIS), an electronic medical record (EMR), and a print system for printing related information and medical records of patients. In some cases, the print system may be already constructed as a part of other systems such as the HIS, LIS, PACS, RIS and EMR. In some cases, some of or all of the systems such as the HIS, LIS, PACS, RIS, EMR and print system may communicate with each other, thus forming a larger electronic information management system. In whichever case, they are included in the examples of the “medical management system” mentioned herein. Other systems that are not mentioned herein but also relate to the management of patient medical records shall also be included in the “medical management system” mentioned herein.

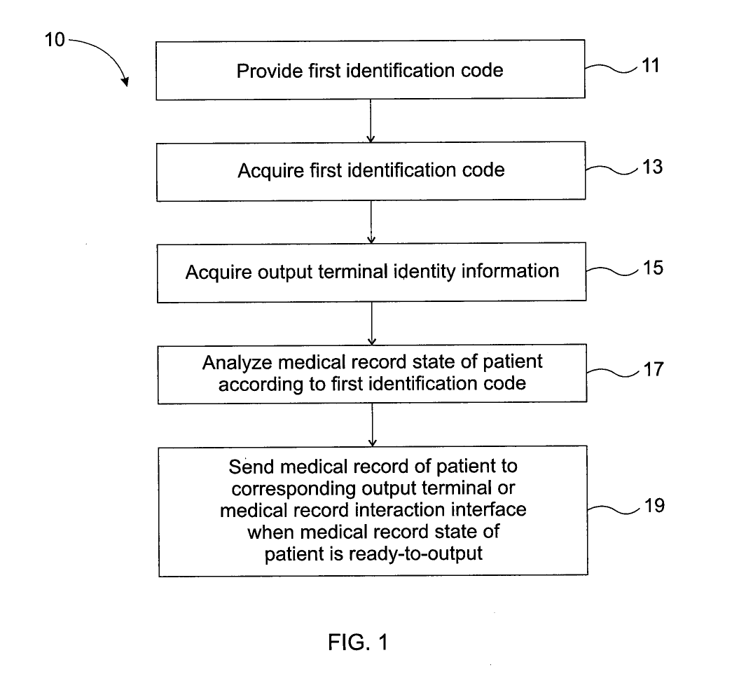

FIG. 1 is a flow chart of a medical record output method 10 according to an example of the present invention. At Step 11: a first identification code is provided. The first identification code comprises patient identity information. The first identification code may be produced while other medical documents, such as a patient registration form and a hospital guide form, that comprise patient identity information are being generated. For different patients, the first identification code is a unique identifier comprising identity information of a corresponding patient.

At Step 13: the first identification code is acquired. In an example, the first identification code is identified by using an application program installed in a mobile terminal and is related with the patient identity information. More specifically, in an example, a scan function of an application program, such as WeChat, installed in the mobile terminal may be used to scan the first identification code, thus acquiring the first identification code. In such an example, the application program is a third-party application program, such as WeChat, installed in the mobile terminal. After the first identification code is acquired by using the third-party application program, an interaction interface, for example a WeChat official account, of the medical record management system is loaded, so that it is possible to interact with the medical record management system. In such an example, the first identification code further comprises loading address information of the interaction interface of the medical record management system.

In another example, the application program is a stand-alone application program used for medical record query. The stand-alone application program can be found by means of online searching, for example, searching in App Store, or by scanning an installation code, for example, a two-dimensional code; then the stand-alone application program is downloaded and installed in the mobile terminal. In this case, the stand-alone application program comprises the interaction interface of the medical record management system. Once the first identification code is acquired through the stand-alone application program, the first identification code can be related with the patient identity information.

The mobile terminal comprises smart electronic devices such as a smart phone, a tablet PC, a portable computer, a smart watch, and smart glasses. The mobile terminal may be operated by a patient or a relative or friend of the patient, or may be operated by any other person in need. In the description below, a person who operates the mobile terminal is referred to as a “user”.

At Step 15: output terminal identity information is acquired. In an example, the method for acquiring the output terminal identity information comprises: providing a second identification code, wherein the second identification code comprises the output terminal identity information; and acquiring the second identification code through the medical record interaction interface and relating the second identification code with the output terminal identity information.

More specifically, all of or some of a plurality of output terminals of the medical record management system may be provided with the second identification code. The plurality of output terminals of the medical record management system may be located at different departments of a medical institution or different places of the medical institution. The second identification code may be adhered to an eye-catching position on the output terminal, for example, on the casing of a print terminal.

In an example, for different output terminals, the second identification code may one-to-one corresponds to the output terminals. In this way, with respect to the medical record management system, each output terminal is uniquely identified. After the user scans or recognizes a second identification code on an output terminal by using the mobile terminal, a medical record of the user can be output or printed at the corresponding output terminal.

In another example, a plurality of output terminals such as a film printer and a report printer may share a same second identification code, that is, the second identification code corresponds to a plurality of output terminals. In this way, with respect to the medical record management system, the second identification code corresponding to the plurality of output terminals is uniquely identified. On one hand, if one of print terminals having a same second identification code in a same department encounters a failure, after scanning or recognizing the second identification code on the output terminal by using the mobile terminal, the user may go to any print terminal corresponding to the second identification code to have the medical record output or printed. On the other hand, different types of reports such as a radiation report, an examination report, or an electrocardiogram report of the user can be output at print terminals that correspond to the same second identification code in different departments.

In an example, the method for acquiring the output terminal identity information further comprises positioning an output terminal nearby by using an application program in a mobile terminal, and obtaining the output terminal identity information. More specifically, for example, a nearby output terminal can be found by using a shake function of the mobile terminal, and then the output terminal identity information is acquired. For another example, the location of an output terminal is determined by using a location function, and in an example, location information of output terminals may be mapped to a planar view or a three-dimensional view of a building structure of the hospital. Similarly, each output terminal may have unique identity information of its own. A plurality of output terminals may also share same identity information.

At Step 17: a medical record state of a corresponding patient is analyzed according to the first identification code. The medical record state is used for indicating a current state of a medical record of the user. In an example, the medical record state may include, but is not limited to information indicating the state of the medical record of the patient in the medical management system, for example, “creating”, “created successfully”, “reviewing”, and “ready to print.” Therefore, the user may arrange the examination schedule thereof according to the medical record state.

At Step 19: When the medical record state of the patient is ready-to-output, a medical record of the patient is sent to a corresponding output terminal or a medical record interaction interface. The user may selectively print the medical record by using the output terminal corresponding to the acquired output terminal identity information or view the received medical record by using the medical record interaction interface.

In the examples of the present invention, the first identification code or the second identification code is a two-dimensional code, or may be other information, for example, a bar code, graphical information or text information. The present invention will be described below by using a smart phone as the mobile terminal and a two-dimensional code as the first identification code.

According to an example of the present invention, the user uses the smart phone to scan the two-dimensional code, so as to acquire an interaction interface of the medical record management system, and interacts with the medical record management system by using the interaction interface. Information of a patient is related with the medical record system by means of the interaction. The interaction interface may be, for example, an application of the medical record management system, a WeChat official account, Weibo, or any other types of social tools. If the interaction interface of the medical record management system is a WeChat official account, the user can follow the medical record management system by scanning the two-dimensional code with the WeChat application in the mobile phone thereof, and relate the patient information with the medical record management system by using the WeChat official account. Herein, the patient information may be one or more pieces of information such as a medical card number of the patient, the name of the patient, a registration number that the patient obtains on the day the patient goes to the hospital, and a department where the patient sees a doctor, as long as the medical record management system can uniquely identify the patient and the medical record of the patient can be acquired from the medical record management system according to the patient information. In other words, the patient information registered with the medical record management system needs to correspond to a patient identifier that the patient uses to see a doctor and make an examination appointment in a medical institution. The medical record management system may output the medical record when the medical record of the patient is ready to output. The medical record being ready to output refers to that the medical record already can be presented to a person in need, for example, the medical record already can be printed for the patient or can be viewed by the patient on the mobile terminal.

In all the illustration herein, the WeChat official account should be comprehended in a broad sense, and it includes various information accounts that can release information on WeChat, for example, a WeChat official account and a WeChat enterprise account.

Alternatively, the first identification code may further comprise information such as a name of the application of the medical record management system, an account number of the WeChat official account of the medical record management system, a Weibo account number of the medical record management system, or an account number of any other interaction tool. Still using the example in which the interaction interface is a WeChat official account, in this case, the user can follow the WeChat official account of the medical record management system by entering account number information of the WeChat official account into the WeChat application in the mobile phone, and then interacts with the medical record management system to relate the patient information with the medical record management system. When the medical record of the corresponding patient is ready to output, the medical record management system transmits the medical record to the user through WeChat. Alternatively, the medical record may also be sent to a user-specified receiving end, such as an email box, as required.

When the interaction interface is Weibo, the user can follow Weibo of the medical record management system by entering a Weibo account number into the Weibo application in the mobile terminal, and then interacts with the medical record management system to register the patient information with the medical record management system. When the medical record of the registered patient is ready to output, the medical record management system transmits the medical record to the user through Weibo (such as a private message function of Weibo). Alternatively, the medical record may also be sent to user-specified a receiving end, such as an email box, as required.

When the medical record management system is a stand-alone application program, the user may search for the application program according to the name of the application program, download the application program, recognize the first identification code through the application program of the medical record management system, and relate the patient information. Then the application program outputs the medical record when the medical record is ready to output, for example, the medical record may be directly transferred to a specified email box through the application.

The medical record output method shown in FIG. 1 achieves output management on patient medical records on the basis of existing output apparatuses, such as print terminals, of a hospital, and it is unnecessary to additionally purchase specialized print devices, which reduces costs, and improves the printing efficiency of medical image films and/or paper reports for patients.

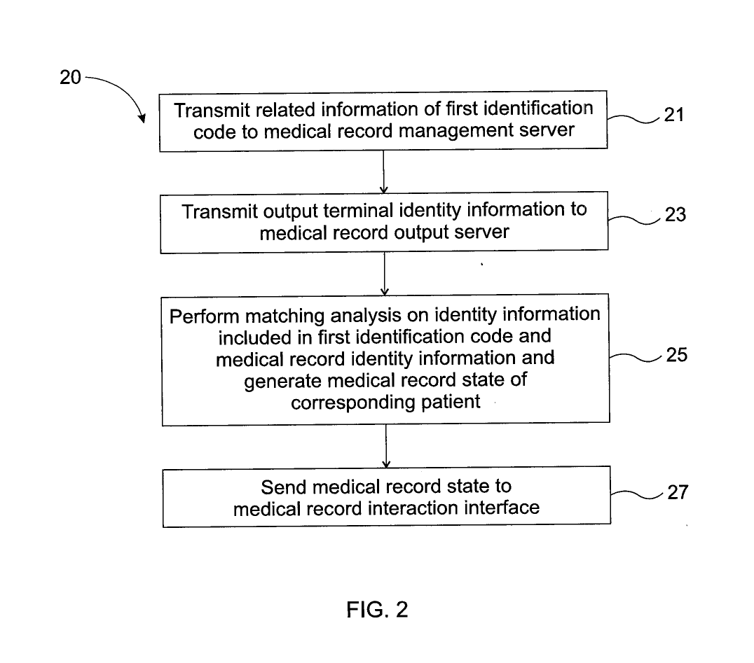

FIG. 2 is a flow chart of a medical record output method 20 according to another example of the present invention. In this example with reference to FIG. 2, we still provide an exemplary but not limitative illustration by using a specific example in which a smart phone is used as the mobile terminal, a two-dimensional code is used as the first identification code, and a WeChat official account is used as the interaction interface of the medical management system. For example, a user scans the two-dimensional code with the smart phone thereof to obtain patient identity information, and in this way, the user follows the WeChat official account of the medical record management system, and interacts with the medical management system through the WeChat official account. Step 17 of the method 10 in FIG. 1 is described exemplarily below with reference to FIG. 2.

It should be particularly noted that, there is no particular sequence in steps of the method 20, and arrows from Step 21 to Step 27 are merely used to make it convenient to make an indicative drawing, but are not intended to limit the execution sequence of any step from Step 21 to Step 27 in FIG. 2.

At Step 21: related information of the first identification code is transmitted to a medical record output server through the medical record interaction interface.

At Step 23: the output terminal identity information is transmitted to the medical record output server through the medical record interaction interface. Herein, the second identification code is used as an example for description. An identification code of any output terminal that has the second identification code is acquired, and the mobile terminal is used for transmitting the identification code to the medical record output server through the medical record interaction interface.

Specifically, when the second identification code is a two-dimensional code, the user may scan the second identification code by using a smart phone thereof, and after acquiring the second identification code, the user transmits the second identification code to the medical record output server through the medical record interaction interface. The medical record output server stores output terminal geographical location information, output terminal type information, or other information representative of an output terminal identity corresponding to each output terminal identity information. Therefore, a particular output terminal can be determined according to the second identification code.

When the second identification code is text information (for example, characters, digits, letters, or any combination thereof), the user may enter the identification code into the smart phone thereof. After acquiring the second identification code, the smart phone can transmits the identification code to the medical record output server through the medical record interaction interface.

At Step 25: the medical record output server performs matching analysis on the identity information included in the first identification code and medical record identity information, and generates the medical record state of the corresponding patient. In general cases, after taking a film of a patient with an image generation apparatus such as X-ray machine, a CT device, an MR device, a DR device, a CR device or other medical image generation devices, a technician sends the medical image to the medical record output server. Alternatively, after diagnosing a disease of a patient, a doctor issues a diagnostic report and sends an electronic report to the medical record output server. Therefore, the medical record output server stores edited medical records to be printed or viewed.

In an example, after receiving the related information of the first identification code, for example, the patient identity information, the medical record output server matches the identity information included in the first identification code with the medical record identity information and generates the medical record state of the corresponding patient. In another example, the user may send an output request to the medical record output server through the medical record interaction interface, and after receiving the output request, the medical record output server performs matching analysis on the identity information included in the first identification code and the medical record identity information and generates the medical record state of the corresponding patient.

At Step 27: the medical record state is sent to the interaction interface. After the medical record output server performs matching analysis and generates the medical record state in Step 25, the medical record output server sends the corresponding medical record state to the interaction interface. In this way, the user can know the state of the medical record thereof.

Once the medical record state of the patient is ready-to-output, the user can have the medical record output by using a corresponding output terminal or view the medical record in an electronic form through the medical record interaction interface. For example, an output terminal having a printing function prints the medical record upon reception of the medical record. When a same identification code corresponds to a plurality print terminals, the user may select a corresponding printer from a group of print terminals according to the type of the medical record, to print the medical record. In an example, the print terminal is provided with a prompt indicating which type of report the print terminal can print, to make it convenient for users to select and operate the print terminal. In another example, after the output terminal identity information is acquired, the user may be informed of, according to an information prompt received on the medical record interaction interface, the type of medical record that the corresponding print terminal outputs.

In all the examples herein, the medical record may be various medical related records that can be output, for example, an examination result, doctor diagnostic descriptions, and medical image information.

The present invention is further illustrated with reference to a specific scenario. Patient B goes to the hospital to see a doctor, and after registration and waiting, patient B sees a physician. The physician asks patient B to take a blood test and a B-scan ultrasonography test. Patient B goes to the B-scan ultrasonography section to make a preregistration and then gets tested; then patient B goes to the blood test section to make a registration and takes a blood test. Generally, the patient needs to wait for a B-scan ultrasonography report and a blood test report, and usually the blood test section and the B-scan ultrasonography section are at different places and more than often than not, their respective report pickup offices are also at different places. Therefore, the patient B has to go to the B-scan ultrasonography pickup office to get the B-scan ultrasonography report after completing the blood test, and then go to the blood test report pickup office to get the blood test report. It is unfair for the patient to rush about like this.

If the hospital employs the medical record output method shown in FIG. 2 for example, such a situation that the patient is facing can be effectively improved, and only a slight modification or even no modification needs to be made on the existing medical record management system of the hospital. In a hospital that employs the medical record output method shown in FIG. 2 for example, patient B notices the two-dimensional code during registration and thus can scan the two-dimensional code to follow the WeChat official account of the medical record management system. After taking the blood test, patient B can find a nearest output terminal having an identification code, scans the identification code and sends the identification code to the medical record output server. The medical record output server identifies the output terminal according to the identification code, and in this way, if the test reports of the patient are ready to output, the output server sends the B-scan ultrasonography report and the blood test report of the patient to the output terminal having the identification code or to the interaction interface of the WeChat official account of the medical record management system. As the patient can query a returned medical record state on the interaction interface, the patient can go to the corresponding output terminal to print the medical record more conveniently according to his own schedule. As can be seen, the use of the medical record output method according to the examples of the present invention allows the patient to use a nearest output terminal to print his/her reports without rushing about. Optionally, when the reports of the patient are ready to output, the medical record output server may send a WeChat message to the patient, to let him know that “the reports are ready to output.”

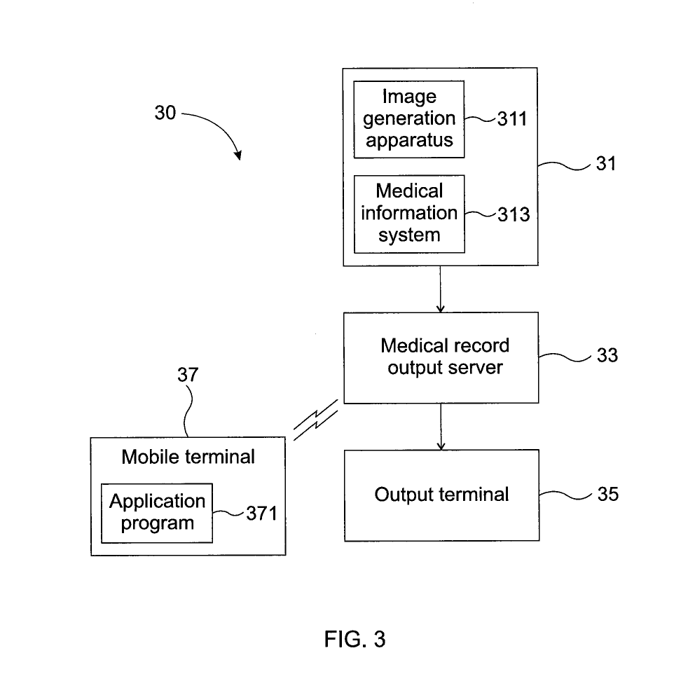

FIG. 3 is a structural schematic diagram of a medical record output system according to an example of the present invention. As shown in FIG. 1, in this implementation manner, the medical record output system 30 comprises a first identification code (not shown), an output terminal 35, and a medical record output server 33.

The first identification code is related with patient identity information when being acquired by a mobile terminal 37.

The mobile terminal 37 is configured to transmit related information of the first identification code and related information of the output terminal to a medical record output server.

The output terminal 35 identity information is acquired by the mobile terminal 37. The output terminal 35 identity information may be adhered, in a form of a second identification code, at an eye-catching position such as the casing. The output terminal 35 identity information may also correspond to an identify code so as to be stored in the medical record output server 33. According to the output terminal identity information, the medical record output server 33 can recognize information of the corresponding output terminal 35, for example, location information and an output type.

The medical record output server 33 is in communicative connection with a medical record generation system 31. The medical record generation system 31 may include an image generation apparatus 311 such as an X-ray machine, a CT device, an MR device, a DR device, a CR device or other medical image generation device, or include a medical information system 313 such as an RIS, a PACS, or an HIS. The medical record generation system 31 may send medical records, such as a medical image film and a patient diagnostic report, edited by a doctor to the medical record output server 33 for outputting.

The medical record output server 33 is configured to analyze a medical record state of a patient corresponding to the first identification code, and when the medical record state of the patient is ready-to-output, send a medical record of the patient to the corresponding output terminal 35 or a medical record interaction interface.

More specifically, in an example, the medical record output server 33 is configured to receive related information of the first identification code and related information of the output terminal, and perform matching analysis on the identity information included in the first identification code and medical record identity information, and generate the medical record state of the corresponding patient.

In another example, the medical record interaction interface is configured to send an output request to the medical record output server 33; after receiving the output request, if the medical record of the patient corresponding to the first identification code is ready to output, the medical record output server 33 sends the medical record of the patient to the output terminal 35 corresponding to the acquired output terminal identity information or the medical record interaction interface.

The user may selectively print the medical record by using the output terminal corresponding to the acquired output terminal identity information or view the received medical record by using the medical record interaction interface.

In the medical record output system according to the present invention, the medical record output server may be a server in an existing report output system of a hospital or a medical institution, and the output terminals may also be output terminals in the existing report output system of the hospital or the medical institution, except that the output terminals are provided with a second identification code or corresponding identity information is stored in the medical record output server.

In an example, the medical record output server is in communication connection with other medical record management systems of the hospital or medical institution, and obtains medical records from these medical record management systems. The “communication connection” herein refers to connection in a communication manner. For example, the connected parties may perform communication therebetween by means of wire connection such as cables; the connected parties may perform communication therebetween by means of wireless communication; or the connected parties may perform communication therebetween by means of wireless communication as well as wire connection such as cables.

To some extent, after being in communication connection with other medical record management systems of the hospital or medical institution, the medical record output system becomes a part of the medical record management system of the hospital or medical institution. In this case, when acquiring the first identification code by using the mobile terminal, the user can relate the mobile terminal with an interaction interface of the medical record output system, the case of which may be as follows: the medical record output system has such an interaction interface as a WeChat official account, and the user can relate the mobile terminal with the interaction interface of the medical record management system after acquiring the first identification code by using the mobile terminal; as the medical record management system is in communication connection with the medical record output system, the mobile terminal can also interact with the medical record output system through the interaction interface.

Although the specific examples of the present invention have been disclosed in the description above with reference to the accompanying drawings, a person skilled in the art can understand that variations or modifications can be made to the disclosed specific examples without departing from the spirit of the present invention. The examples of the present invention are merely used to illustrate the present invention rather than limiting the present invention.

1. A medical record output method, comprising:
a) providing a first identification code, wherein the first identification code comprises patient identity information;
b) acquiring the first identification code;
c) acquiring output terminal identity information;
d) analyzing a medical record state of a corresponding patient according to the first identification code; and
e) sending a medical record of the patient to a corresponding output terminal or a medical record interaction interface when the medical record state of the patient is ready-to-output.

2. The medical record output method according to claim 1, wherein step d) further comprises:
d1) transmitting related information of the first identification code to a medical record output server through the medical record interaction interface;
d2) transmitting the output terminal identity information to the medical record output server through the medical record interaction interface;
d3) performing matching analysis on the identity information included in the first identification code and medical record identity information by the medical record output server, and generating the medical record state of the corresponding patient; and
d4) sending the medical record state to the medical record interaction interface.

3. The medical record output method according to claim 1, further comprising:
sending an output request to the medical record output server through the medical record interaction interface; and
after receiving the output request, performing matching analysis on the identity information included in the first identification code and medical record identity information by the medical record output server, and generating the medical record state of the corresponding patient.

4. The medical record output method according to claim 1, wherein step c) further comprises:
providing a second identification code, wherein the second identification code comprises the output terminal identity information; and
acquiring the second identification code through the medical record interaction interface, and relating the second identification code with the output terminal identity information.

5. The medical record output method according to claim 4, wherein the second identification code one-to-one corresponds to an output terminal.

6. The medical record output method according to claim 4, wherein the second identification code corresponds to a plurality of output terminals.

7. The medical record output method according to claim 4, wherein the first identification code or the second identification code comprises a two-dimensional code, a bar code, graphical information, or text information.

8. The medical record output method according to claim 1, wherein step c) further comprises positioning a nearby output terminal by using an application program in a mobile terminal, and obtaining identity information of the output terminal.

9. The medical record output method according to claim 1, wherein an application program for acquiring the first identification code is a third-party application program installed in a mobile terminal, and the method further comprises loading an interaction interface of a medical record management system after the first identification code is acquired through the third-party application program.

10. The medical record output method according to claim 1, wherein an application program for acquiring the first identification code is a stand-alone application program for medical record query.

11. The medical record output method according to claim 10, further comprising finding the stand-alone application program by means of online searching or by scanning an installation code, downloading and installing the stand-alone application program in a mobile terminal.

12. The medical record output method according to claim 1, further comprising printing the medical record by using the output terminal corresponding to the acquired output terminal identity information.

13. A medical record output system, comprising:
a first identification code, which is related with patient identity information when being acquired by a mobile terminal;
an output terminal, wherein output terminal identity information is acquired by the mobile terminal; and
a medical record output server, which is configured to analyze a medical record state of a patient corresponding to the first identification code, and send a medical record of the patient to the corresponding output terminal or a medical record interaction interface when the medical record state of the patient is ready-to-output.

14. The medical record output system according to claim 13, wherein:
the medical record output server is configured to receive related information of the first identification code and related information of the output terminal, and perform matching analysis on the identity information included in the first identification code and medical record identity information, and generate the medical record state of the corresponding patient.

15. The medical record output system according to claim 13, wherein:
the medical record interaction interface is configured to send an output request to the medical record output server; and
after receiving the output request, if the medical record of the patient corresponding to the first identification code is ready to output, the medical record output server sends the medical record of the patient to the output terminal corresponding to the acquired output terminal identity information or the medical record interaction interface.
